(19) United States
(12) Patent Application Publication
(10) Pub. No.: US 2007/0248256 A1
(43) Pub. Date: Oct. 25, 2007

(54) System and method for producing a digital radiographic image with a notation to indicate the exposure side of the image

(76) Inventor: Carl E. Fabian, Miami, FL (US)

Correspondence Address: ROBERT M. SCHWARTZ, P.A., P.O. BOX 221470, HOLLYWOOD, FL, 33022, US

(21) Appl. No.: 11/357,522

(22) Filed: Feb. 17, 2006

(51) Int. Cl. G06K 9/00

(52) U.S. Cl. 382/132

(57) ABSTRACT

A device is provided which will electronically impart upon a latent image, a notation which will permanently identify its exposure side, such identification forming an integral part of the resultant digitized image. In one particular embodiment of the present invention, the notation is chirally asymmetric, so as to provide a viewer with apparent notice when the image has been reversed.

### BACKGROUND OF THE INVENTION

1. Field of the Invention

The invention relates to the field of medical radiography, whereby an image is produced by directing an x-ray beam at a part of the body, generally for diagnostic purposes. More particularly, the present invention relates to the field of digital radiography and system and method for imparting a permanent indicator on a digital image which identifies the side of the image that received the incident x-ray beam, herein termed the “exposure side”.

2. Description of the Related Art

A medical radiograph is the X-ray image of some part of the body produced by an X-ray beam originating from an X-ray tube. The X-ray beam passes first through the body and then through an X-ray film cassette which is a light-proof, flat box of rigid construction. When rendering a diagnosis from a radiographic film it is necessary for the film reader to know which side of the body is being viewed. Since the body is generally symmetrical, right-sided structures are similar in appearance to left-sided structures, except that they are reversals or mirror-images of one another. For example, an x-ray image of the left foot, if viewed from the back of the exposed film will look like a right foot. Since radiographs are typically transparent and can be viewed from either side, it is possible for x-ray images of one side of the body to become confused with the other. For this reason when a medical radiograph is performed of some part of the body, it is necessary for the x-ray technologist to indicate which side of the body is represented on the film, usually by affixing a radiopaque “R” or “L” marker on the cassette cover.

Not infrequently however, the technologist places the wrong marker on the cassette or for one reason or another the marking cannot be seen on the film, being either obscured or simply omitted, so that the technologist must then mark the film after it is developed, using an adhesive label, wax pencil, ink, or even scratch marks. The incidence of absent or incorrect right/left marking due to human error is quite substantial, reportedly as high as 30% in some series.

When the film is improperly marked and the physician interpreting the film recognizes the error he will often try to locate the technologist who performed the study to obtain clarification. When the question cannot be resolved in this manner, the patient may be recalled for a repeat examination which involves, time, inconvenience, expense, and additional radiation exposure. Further in cases where the error goes undetected, inappropriate medical treatment, sometimes serious, may be the result, often leading to lawsuits. Since the primary cause of this right/left confusion stems from the fact that the film is transparent and may be viewed from the front (i.e., the exposure side) or the back, identifying the front side of the film for the viewer will prevent the inadvertent viewing of the film from the wrong side and thereby permit ready determination of which side of the body is represented thereon.

A number of patents address the left/right marker issue in radiographs recorded on film. For example, U.S. Pat. No. 5,123,040 to Fabian, issued on Jun. 16, 1992, entitled MARKED X RAY FILM WITH MODIFIED CASSETTE FOR IDENTIFYING THE EXPOSURE SIDE OF A MEDICAL RADIOGRAPH, discloses a sheet of film having a cutout adapted to engage a key. A marker is permanently fixed along at least one edge of the film. The marker cooperates with the key and the cutout to identify the side of the film sheet facing the X-ray tube during exposure. U.S. Pat. Nos. 5,077,778, 5,189,689, 5,195,122 and 5,307,397 to the present inventor, similarly describe systems and methods for identifying the exposure side of a medical radiograph made in a film cassette.

U.S. Pat. No. 5,307,397, issued to the instant inventor on Apr. 26, 1994, provides an X-ray film cassette with a permanent marking means for identifying the side of the radiographic film that faced the X ray tube during exposure. The marking means is comprised of chirally asymmetric radiopaque and/or light-opaque letters or markings permanently mounted in the film cassette to intersect overlapping portion of an X-ray path projected during exposure. In film/screen cassettes the process of creating an image is an ‘analog’ process. No latent image is utilized and no electronic digitization of the image occurs. Rather, the incident x-ray beam, after penetrating the patient, enters the cassette and passes through the film and both screens. It causes both screens to emit light which in turn directly produces the exposure or darkening of the adjacent film, to a degree analogous to the energy of the beam. Since light is emitted from both screens, proper marking of the film requires the placement of matching markers on both screens, opposing one another in exact alignment. Accomplishing this in turn requires a specially constructed appliqué, as described in U.S. Pat. No. 5,077,778 issued to the instant inventor on Dec. 31, 1991.

However, radiographic images presently exist that are not initially recorded onto film during an analog process. Rather, presently there exists means for taking digital radiographic images. The production of a digital radiographic image requires a completely different process from that of the film/cassette radiograph recorded using an analog process. With the advent of digital technology, the imaging process still utilizes an x-ray beam and a light-tight, flat box, but the similarity ends there. Film is no longer used to register the image but instead, the x-ray cassette contains what is termed an “imaging plate” (i.e., typically a plate incorporating an excitable phosphor layer), a device capable of registering the latent image (a matrix of excited phosphor crystals) which image is subsequently digitized. The digital image is comprised of a large number of ‘pixels’ (picture elements) arranged in a grid work known as a ‘matrix’. The digital image at this point is therefore a virtual image, an image which exists in electronic form only, a fact that offers numerous advantages over the traditional film image.

A digital image can be electronically manipulated in many ways, e.g.: contrast enhanced, magnified, turned upside-down or reversed to its mirror image, and it can be transmitted electronically to a viewing screen elsewhere for interpretation, or transferred to film to produce a radiograph for permanent recording and storage. With such electronic manipulation, the digital image can be modified long after the exposure, according to medical dictates. A particular area of interest can be selected for magnification or have its contrast altered to better enhance bone detail or soft tissue detail, as needed by the viewing physician and this can be done without the need to repeat the examination, a common occurrence with film/screen radiography.

However, despite the ease of manipulation of a digital image, there are currently no systems or methods used for identifying the exposure side of a digital radiograph.

Referring to FIGS. 3 and 4 of the instant application, there is illustrated the problem arising when the exposure side of a digital radiographic image is not properly identified. More specifically, referring to FIG. 3, there is shown a drawing representing a digital image 30 of a left foot, taken without any indicia, notation, marker or “L” identification of exposure side (i.e., the side of the image that received the incident x-ray beam). FIG. 4 shows a drawing representing the electronically reversed digital image 40 of the same unmarked left foot of FIG. 3. The image 40 shown in FIG. 4, although the same digital image 30 of a left foot, seen as its mirror image, now appears to be a right foot.

Further, U.S. Patent Application Publication Nos. 2002/0081010 and 2005/0104018 to Chang et al., discloses a method and system for acquiring full spine and full leg images using flat panel digital radiography. Chang et al., discloses the acquisition of multiple, standard sized radiographs for purposes of constructing a larger composite radiographic image. As disclosed in Chang et al., fiducial markers are superimposed on the image of the patient so that the distortion introduced by the change in position of the detector relative to the direction of the primary radiation for sequential acquisitions can be corrected. The '010 Chang publication discloses an elongated guide 30 of radiopaque material, such as lead. The '018 Chang publication discloses that the fiducial marker can be comprised of any shape, for example, a circle, square triangle, and the like. As such, the fiducial markers described in the Chang publications are symmetrical, and thus would not assist a physician in detecting the exposure side of a radiograph (i.e., a triangle, circle, square, bar, etc. are the same forward and reverse).

As such, there is a need for a system and method for identifying the exposure side (i.e., the side of the image receiving the incoming x-ray beam) of a digital radiograph. What is further needed is a system and method for identifying the exposure side of a radiograph, such that, it becomes possible for the reading physician to determine which side of the body is actually represented on the image, even though the right/left marking of the image is incorrect or omitted.

### SUMMARY OF THE INVENTION

It is accordingly an object of the invention to provide a System And Method For Producing A Digital Radiographic Image With A Notation To Indicate The Exposure Side Of The Image, which overcomes the above-mentioned disadvantages of the heretofore-known devices and methods of this general type.

A device is provided which will electronically impart upon a latent image a notation which will permanently identify its exposure side, such identification forming an integral part of the resultant digitized image. In one particular embodiment of the present invention, the notation is chirally asymmetric, so as to provide a viewer with apparent notice of a reversed image.

Other features which are considered as characteristic for the invention are set forth in the appended claims.

Although the invention is illustrated and described herein as embodied in a System And Method For Producing A Digital Radiographic Image With A Notation To Indicate The Exposure Side Of The Image, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

The present invention and its many features and advantages will be more apparent after reading the following detailed description which refers to the accompanying drawings illustrating the working parts of this invention. Like reference numerals refer to like items throughout the drawing.

FIG. 1 is a front plan view of a closed digital x-ray cassette, containing external markers indicating the location and disposition of internal notations, in accordance with one particular embodiment of the present invention.

FIG. 2 is a front plan view of one particular embodiment of an imaging plate contained in a digital x-ray cassette, such as the digital x-ray cassette of FIG. 1, in communication with a notation identifying the exposure side of a radiograph.

FIG. 3 is a representative view of a frontal digital image of the left foot, taken without “L” identification or identification of exposure side.

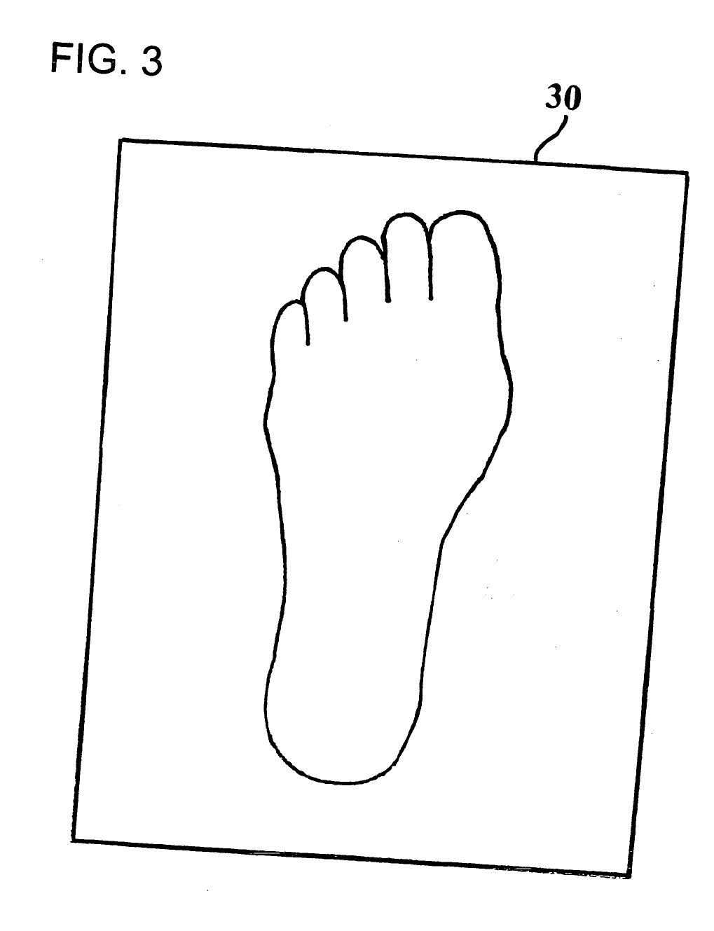

FIG. 4 is a representative view of the digital image of FIG. 3, showing the unmarked left foot after electronic reversal.

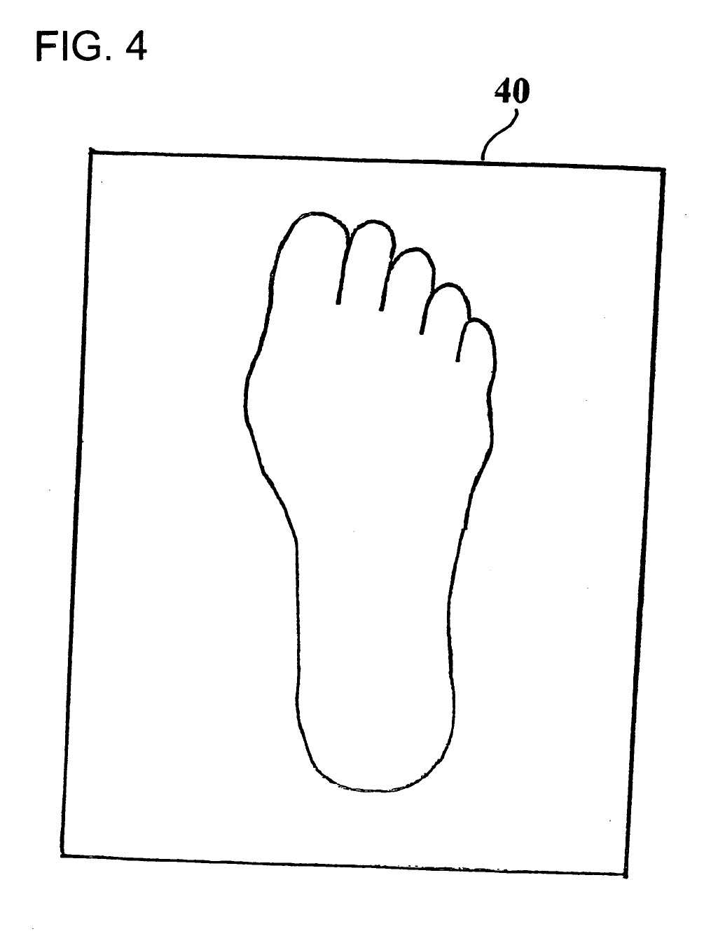

FIG. 5 is a representative view of a frontal digital image of the left foot taken in a cassette with exposure side notated, in accordance with one particular embodiment of the present invention.

FIG. 6 is a representative view of the digital image of FIG. 5, showing the appearance of the left foot and accompanying notations, after electronic reversal.

FIG. 7 is a schematic diagram of a system, in accordance with one particular embodiment, for converting a latent image on an imaging plate into digital data.

FIG. 8 is a flowchart representing one particular method for using one particular embodiment of the invention.

FIG. 9 is a front plan view of another particular embodiment of an imaging plate in communication with a notation to identify the exposure side of a radiograph.

### DESCRIPTION OF THE PREFERRED EMBODIMENTS

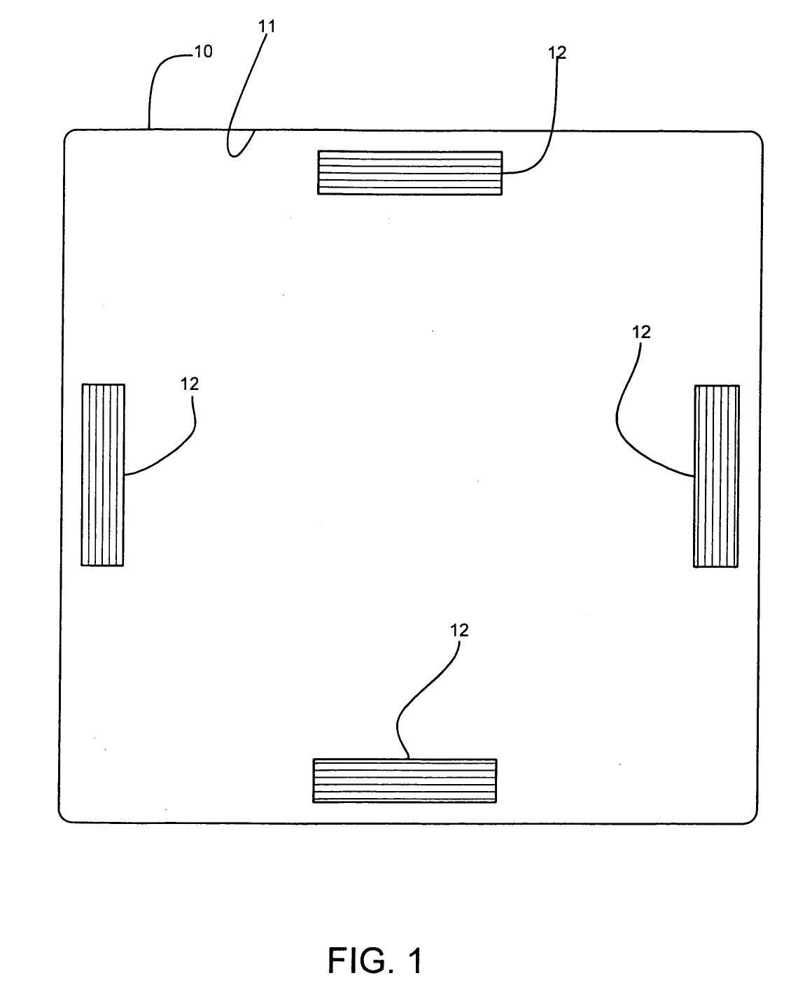

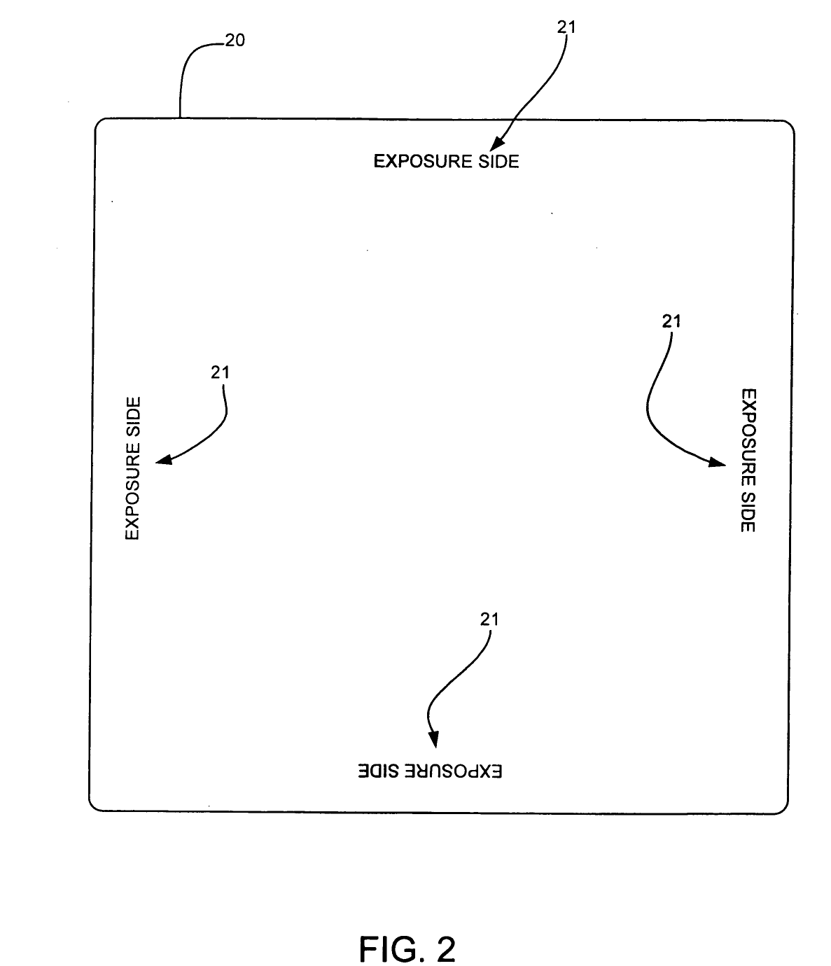

The production of a digitized image involves a complex process which is briefly summarized below. Incident x-ray photons, after first passing through the portion of the patient to be imaged, enter a cassette (10 of FIG. 1) and strike an imaging plate (for example, 20 of FIG. 2), producing a latent image on its ‘photostimulable phosphor’ layer (hereinafter, the “phosphor layer”). Typically, a phosphor layer contains at least one active layer of a fluorescent phosphor material. In one preferred embodiment, the active portion of the phosphor layer includes crystals of barium fluorohalide and a small amount of europium. During digital radiography (also referred to as “computed radiography”), photon energy of an incoming x-ray beam excites different portions of the phosphor layer differently, as a result of photoelectric interaction, creating a latent image which is temporarily retained in the phosphor layer.

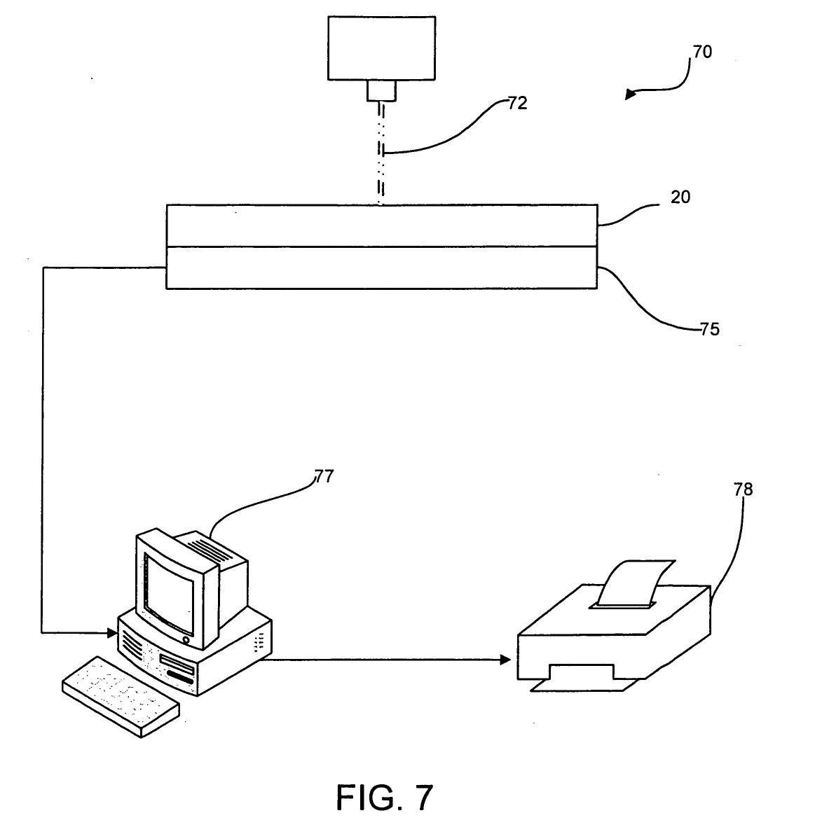

Subsequently, referring now to FIG. 7, the imaging plate 20 is removed from the cassette and sent through an apparatus wherein it is subjected to secondary stimulation by a scanning laser beam 72 from a laser, such as a helium-neon laser. This secondary stimulation causes a ‘photostimulable luminescence phenomenon’ in which the energy stored in the latent image emits blue-violet light in proportion to the energy stored, which light is converted to a digitized image using a device 75 for converting the energy emitted as light into a digital representation of that energy. Such a device could include a photosensor (i.e., such as a photomultiplier tube, a CCD or a CMOS) and/or other image processing components to produce digital data representative of the latent image from the plate 20. The data representing the digital image are stored electronically as pixels in a matrix, and can be stored in any desired storage medium, such as in a data file stored in non-volatile memory on a server (not shown) or of a computer 77. The data file can additionally be stored more permanently on a disk or ROM. The stored digital image can be viewed and/or manipulated using the computer 77, or printed to a hard copy on either paper or film using an appropriate printer 78. Once the image has been digitized and stored, the imaging plate is exposed to intense white light causing the plate to be electronically erased.

As stated above, it is critical in the interpretation of x-ray images to establish which side of the body is actually represented on the image and a common cause of error in this regard is to mistakenly identify which side of the body is depicted, generally resulting from improper labeling of the cassette by the technologist. The present invention provides a fool-proof system and method for identifying the exposure side of a digital image, not requiring human participation. For example, such system and method does not rely on the placement of “L” or “R” tags by a human, and thus avoids the problems caused by using the wrong tags or omitting such tags.

More particularly, the instant invention provides a system and method wherein a particular marker or notation is placed on the phosphor of the imaging plate to identify the exposure side. This results in an identification that occurs automatically, and is not subject to human error. Additionally, the notation and/or marker becomes an integral, permanent part of the image, regardless of how the image is subsequently modified or manipulated electronically. Every image produced in such a marked cassette will contain a notation indicating the side of said image that received the incident x-ray beam (i.e., the exposure side). This information becomes a permanent part of the image itself, regardless of subsequent electronic manipulation, and will permit the reader of the resulting image to determine which side of the body is represented on the image.

Referring now to FIGS. 1-2 and 5-6, wherein like reference numerals refer to like elements, there is shown one particular embodiment of a device for marking the exposure side of a digital radiograph, in accordance with the present invention.

Referring particularly, to FIG. 1, there is shown the outer housing of a digital radiographic (x-ray) cassette 10. Digital radiographic cassette 10 includes a light-proof, rigid enclosure that is able to open and close and an imaging plate (such as, 20 of FIG. 2) enclosed therein. In the present particular embodiment, the front surface 11 of the digital cassette 10 will bear indication(s) 12, generally indicating the disposition of notations on the surface of the imaging plate within, to inform the technologist that the cassette is a marked cassette. Additionally, the indications 12 inform the technologist of the location of the internal notations to assist in positioning the body part to be examined, ensuring that such placement does not superimpose any desired body part onto a notation on the underlying imaging plate. In the example of FIG. 1, the indications on the front surface 11 generally correspond to the location, size and configuration of such notations on the underlying imaging plate (20 of FIG. 2). Note that this is not meant to be limiting, as fewer or more indications 12 may be used on the front surface 11 of the digital cassette. Additionally, the indications need not be identical to each other.

Note that, in one particular embodiment, the indications 12 on the front surface 11 of the housing of the digital cassette 10 are non-opaque to x-rays, such that the indications 12 do not interfere with the passage of x-rays through the front surface 11. In such an embodiment, the notations (21 of FIG. 2) would either already be written to the phosphor layer of the imaging plate (20 of FIG. 2), or would be printed in an opaque material to the imaging plate (20 of FIG. 2) or an intervening plate (i.e., a glass plate between the housing 10 and imaging plate 20).

Alternatively, the indications 12 can be radiopaque materials fixed to the front surface 11 of the digital cassette 10, so as to register a notation on the underlying imaging plate (20 of FIG. 2) by permitting the incident beam to pass around, but not through, the indications 12.

Referring more particularly to FIG. 2, there is shown the front surface of an imaging plate 20, including marker notations 21 fixed to a surface thereof, such that exposure of the plate produces a resultant image including the marker notations 21 integrally formed therewith. For example, the marker notations 21 can be printed above or below the external surface of the imaging plate 20 in materials opaque to light, such as paper, metal and/or tape, so as to prevent the incident beam from exciting any underlying phosphors. Further, the marker notations 21 could be placed directly on the imaging plate, in place of phosphors, in those locations. Further, as noted above, such marker notations 21 could be opaque markers placed on an intervening medium, such as on a glass plate (not shown) located in the digital cassette housing (10 of FIG. 1) between the front surface (11 of FIG. 1) and the imaging plate 20. Alternately, if desired, the notation can be physically incorporated as a notation directly upon the image sensor used in converting the latent image to a digital image, or may otherwise be affixed to the digitized image file, prior to its initial storage, using the software or firmware of the image processing system used to digitize the latent image.

Additionally, the indications need not be identical to each other. In the instant embodiment, the marker notations are the actual words “EXPOSURE SIDE”, which is preferred in the instant embodiment. However, this is not meant to be solely limiting, as the marker notation 21 can be made from any marker that is “chirally asymmetric” (i.e., having a different appearance when reversed to its mirror image). Symbols, drawings and figures can additionally be chirally asymmetric and used as the notation 21. However, most preferably, the notation 21 is made up of letters and/or numbers (i.e., standard alpha-numeric characters).

For example, in one preferred embodiment of the instant invention shown more particularly in FIG. 2, identification is accomplished by producing a notation, usually comprised of lettering, on the photofluorescent screen of the imaging plate. As used herein the term “notation”, “marker”, and/or “marker notation”, refers to whatever designation is chosen to positively identify the exposure side of the imaging plate 20 (i.e., the side first receiving the incident beam). The notation, being opaque, functions by preventing the transfer of visible light, which would otherwise contribute to the latent image in the underlying phosphor layer, from being transferred to the digital image, thus, becoming an integral part of the digital image. To perform this function the notation may either overlie or block a portion of the underlying phosphor, as would result from an adhesive attachment of such notation to the phosphor or applying an opaque substance such as ink or paint to create the notation. In another embodiment the notation may be incorporated by some means into the phosphor itself, by removal of portions of the phosphor layer through selective etching or actual cutting out of the phosphor crystals. By whatever means is chosen, the notation will prevent the light incident upon the notation from contributing to the latent image, and thus to the digital image (i.e., the notation results from a blackened portion of the phosphor layer, unexcited by incident light).

The notation is most preferably, made up of letters, numbers and/or symbols that are “chirally asymmetric”. Being “chirally asymmetric” means that if the notation becomes reversed, its image must look different, e.g. in the case of lettering, it will read backwards, thereby making it readily apparent that it has been reversed. Notations such as “O”, “X”, or a word such as “OTTO”, as well as symbols such as a circle or square, for example, all read the same forwards and backwards and are therefore not chirally asymmetric, and would not be used for purposes of this invention.

As the imaging plate 20 has only one phosphor layer, there is no need for the two opposing markers needed for optimal film marking in film/screen cassettes. Only the one phosphor layer of the imaging plate 20 needs such a notation to accomplish the desired identification of the exposure side of the image. Nonetheless, it may be deemed desirable by the user to distribute more than one such notation around the periphery of the imaging plate 20, as shown in FIG. 2, wherein four marker notations 21 are affixed to the imaging plate 20. Note that this is not meant to be limiting, as fewer or more indications 20 may be used.

As disclosed above, once the imaging plate 20 is exposed, the phosphor layer on that plate retains a latent image of the imaged body part and notation(s) 21 (i.e., as a pattern of non-excited phosphors corresponding to the notation). The latent image including the notations is digitized and data relating to the resulting digital image are stored. When the digitization process is completed and the digital image data are transmitted to an appropriate destination, the notation becomes an integral part of the digital image data file, and thus of the digital image itself. Resultantly, the notation becomes permanently a part of the digital image that is transferred with it, and subsequent electronic manipulation will not, accidentally erase or change it.

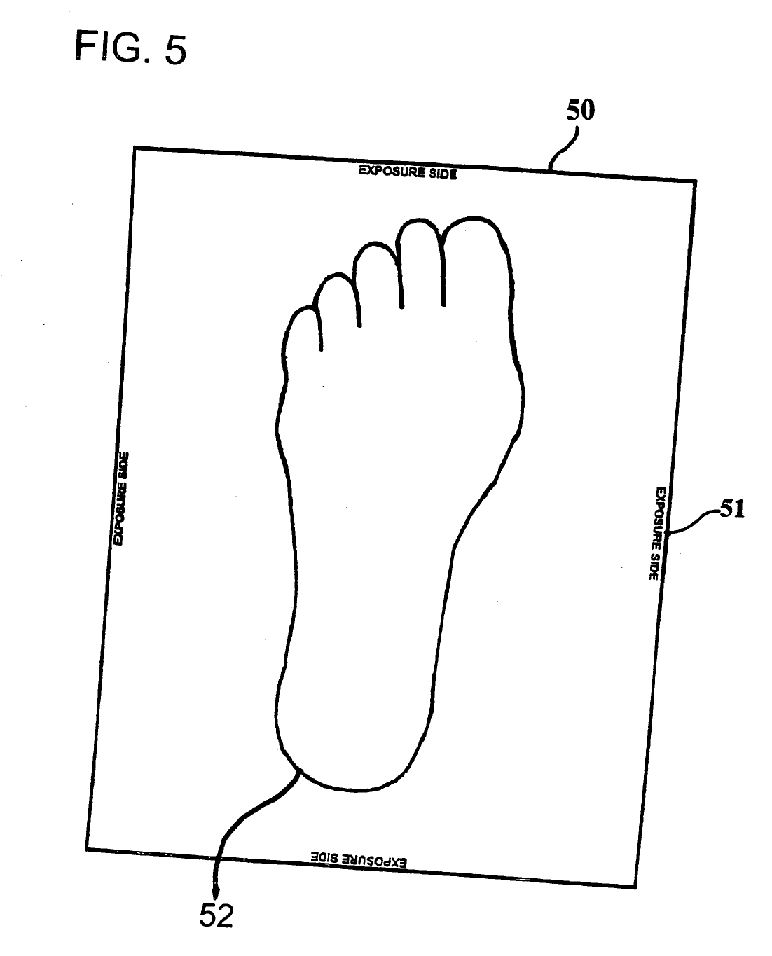

Referring now to FIG. 5, there is shown a digital image 50 of a left foot 52 including as an integral part of the image notations 51 resulting from the notations (21 of FIG. 2) on the phosphor layer during exposure. In the instant embodiment, the notations 51 include the phrase “EXPOSURE SIDE”, so as to leave little room for subjective interpretation. Note that in FIG. 5, the notations, whether seen right side up, upside down, or sideways, all read in the proper direction and are immediately recognizable as such. As such, it can be told by the appearance of the foot 52 in the digital image 50, the great toe lying to the viewer's right, and the EXPOSURE SIDE notation reading properly in a forward direction that the foot is actually a left foot.

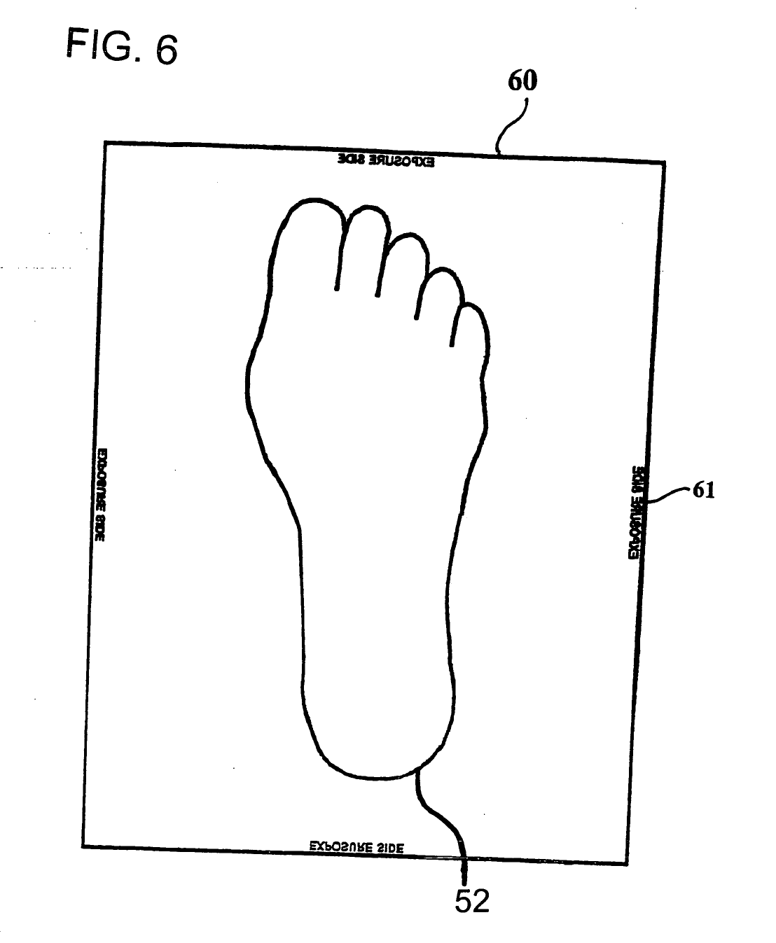

Referring now to FIG. 6 there is shown a drawing representative of a digital image 60, which is a reversal of the digital image (50 of FIG. 5). Note that the foot in the digital image 60 is the same left foot 52 of FIG. 5, only, because the image has been reversed, it now appears to be a right foot. However, the exposure notations (51 of FIG. 5) have additionally been reversed in the digital image 60 of FIG. 6.

More particularly, the exposure side notations 61 now read backwards, indicating to even a casual reviewer that a reversal has occurred and, correspondingly allowing the image to be correctly identified as a left foot 52, versus a right foot.

In view of the foregoing, it can be seen that if a digital image of a body part is later manipulated electronically, it can be reversed to its mirror image with the push of a button. When such reversal is performed, left will appear to be right and vice versa, as seen in FIGS. 5 and 6. However, using the instant invention, the notation(s) indicating the exposure side of the image will also undergo reversal, being integrally part of the digital image data, and always present. While the reversal of the body part may not be apparent to the viewer, using the above described invention, the reversal of the notation (i.e., in the preferred case, the backwards printing of the lettering) will instantly alert the viewer that a reversal has occurred (as shown in FIG. 6), and that the image is being looked at from its wrong side (i.e., the non-exposure or back side). This recognition will avoid the confusion that occurs commonly when right is mistaken for left and vice versa.

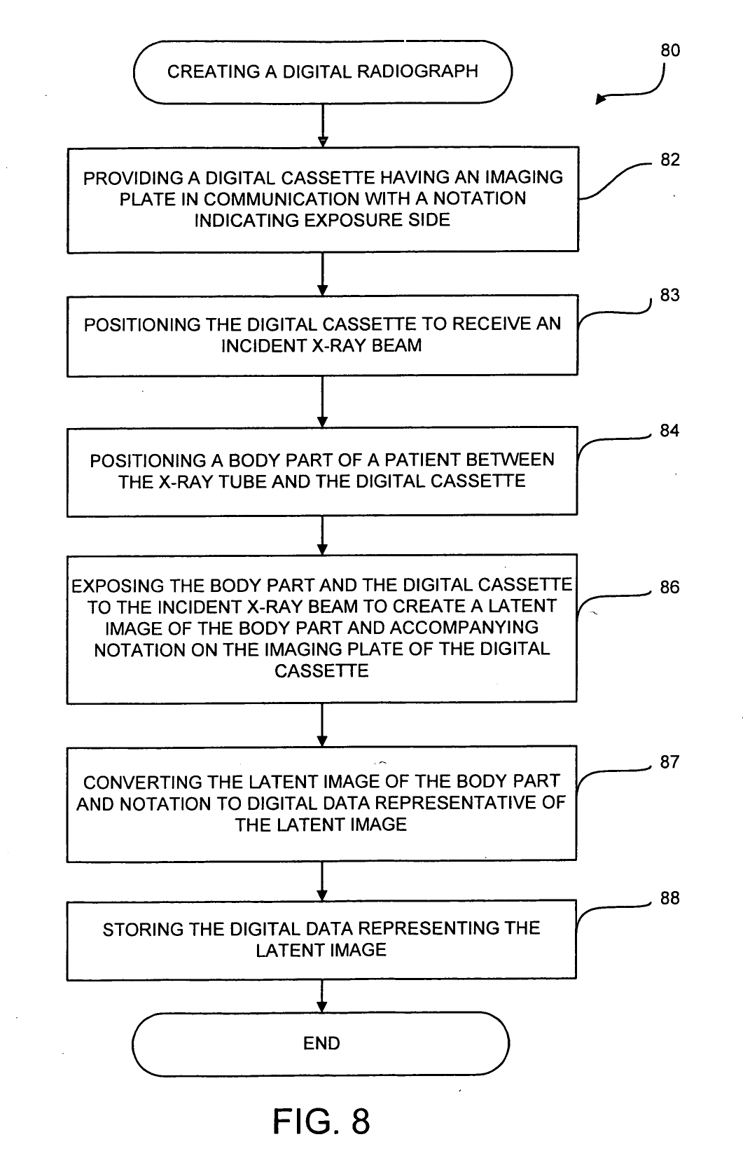

Referring now to FIG. 8, there will be described a method 80 for creating or producing a digital radiographic image in accordance with one particular embodiment of the instant invention. A digital cassette (such as digital cassette 10 of FIG. 1) is provided including an imaging plate in communication with a notation indicating the exposure side of the imaging plate, such that the notation will become part of the latent image after exposure. Step 82. As noted above, the notations may be on the imaging plate, in the phosphor or part of a surface of the housing of the digital cassette. In the instant embodiment, the digital cassette includes on a front surface thereof, an indication related to the underlying notations on the imaging plate, in order to assist a technician in not locating a body part over the underlying notations. The digital cassette is positioned to receive an incident x-ray beam. Step 83. A body part is positioned relative to the digital cassette. Step 84. The aligned body part and digital cassette will be exposed to an incident x-ray beam thus creating a latent image on the imaging plate of the exposed body part and the accompanying notation. Step 86. Then the latent image on the imaging plate (including the latent image of the notation) is converted to digital data representative of the digitized latent image, which digital data includes digital pixel representations of the notation, such as by using the system of FIG. 7. Step 87. The resultant data file is stored for later use. Step 88. Note that as stated above, the data file can be stored electronically, or in hard copy, with the image being reproduced and printed on film from the digital data.

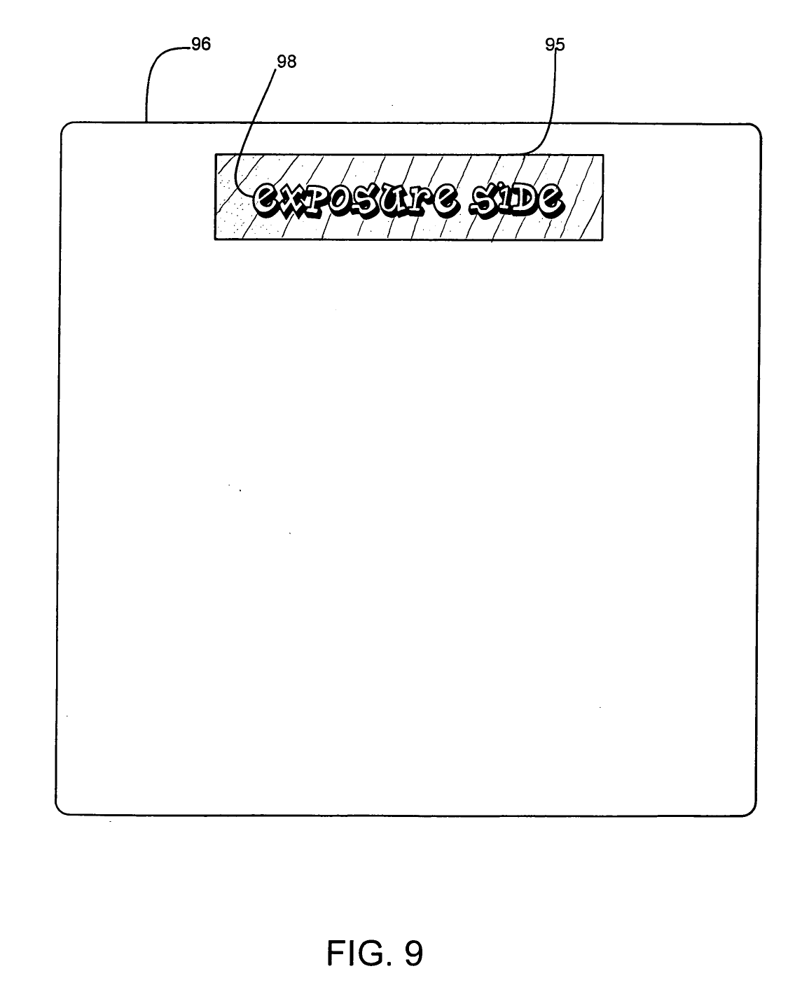

In an alternate embodiment shown in FIG. 9, an opaque tag 95 can be affixed to, or in communication with, an imaging plate 96. The opaque tag 95 has the notation 98 removed therefrom, in order to place the notation into the resultant digital image. In contrast to the above-described embodiments, instead of blocking the light to form the chirally asymmetric notation, the opaque tag 95 creates a dark zone, like a label, while the cutout notation 98 will be lit by the incident radiation. Thus, the chirally asymmetric notation would appear lighter than the dark background, and thus, would be noticeable for purposes of the present invention. Such tag could be made of any suitable opaque material, such as paper, metal, tape, etc.

I claim:

1. A system for producing a digital radiograph, comprising:
a digital radiographic cassette, including:
an imaging plate including a fluorescent phosphor reactive to incident radiation; and
at least one chirally asymmetric notation in communication with said imaging plate;
an imaging device for converting a latent image on said imaging plate into digital data, said latent image including an image of said at least one chirally asymmetric notation.

2. A radiographic cassette for creating digital images of at least a body part, the radiographic cassette, comprising:
a light-proof enclosure;
an imaging plate including a fluorescent phosphor reactive to incident radiation, said imaging plate removably located in said light-proof enclosure; and
at least one asymmetric notation in communication with said imaging plate.

3. The radiographic cassette of claim 2, wherein said imaging plate includes an active layer of a fluorescent phosphor.

4. The radiographic cassette of claim 3, wherein said fluorescent phosphor includes barium fluorohalide and europium.

5. The radiographic cassette of claim 2, wherein said notation is a chirally asymmetric notation.

6. The radiographic cassette of claim 5, wherein said notation is generally composed of standard alpha-numeric characters.

7. The radiographic cassette of claim 5, wherein said notation includes a symbol to indicate the exposure side.

8. The radiographic cassette of claim 2, wherein said notation is affixed to said imaging plate and blocks the production of a latent image in the underlying portion of the phosphor layer.

9. The radiographic cassette of claim 8, wherein said notation includes at least one opaque letter.

10. The radiographic cassette of claim 8, wherein said notation includes at least one opaque number.

11. The radiographic cassette of claim 8, wherein said notation includes at least one opaque figure.

12. The radiographic cassette of claim 8, wherein said notation is affixed to said imaging plate by applying an opaque substance to the imaging plate.

13. The radiographic cassette of claim 12, wherein the opaque substance is ink.

14. The radiographic cassette of claim 8, wherein said notation is affixed to said imaging plate by applying adhesive.

15. The radiographic cassette of claim 8, wherein said notation may be contained on adhesive tape.

16. The radiographic cassette of claim 8, wherein said notation may be etched into a surface of said imaging plate.

17. The radiographic cassette of claim 8, wherein said notation may be produced by removing a portion of said phosphor layer.

18. The digital cassette of claim 2, additionally including an indication on said light-proof enclosure, said indication aligned with said notation.

19. A method of producing a digital radiograph, comprising the steps of:
providing a digital cassette including:
an imaging plate including a fluorescent phosphor reactive to incident radiation; and
at least one chirally asymmetric notation in communication with said imaging plate;
positioning a body part relative to the digital cassette;
exposing the body part and aligned digital cassette to incident radiation to create a latent image including the notation in the fluorescent phosphor;
converting the latent image to digital data representative of the latent image.

20. The method of claim 19, wherein said digital cassette additionally includes an indication associated with the notation.
